(19) United States
(12) Patent Application Publication
(10) Pub. No.: US 2017/0057281 A1
(43) Pub. Date: Mar. 2, 2017

(54) Rim Protector

(71) Applicant: Gary L. Hutchens, Lathrop, CA (US)

(72) Inventor: Gary L. Hutchens, Lathrop, CA (US)

(21) Appl. No.: 15/253,047

(22) Filed: Aug. 31, 2016

Related U.S. Application Data
(60) Provisional application No. 62/212,049, filed on Aug. 31, 2015.

(51) Int. Cl. B60B 7/00; B60S 3/04; B60S 1/66

(52) U.S. Cl. CPC B60B 7/00; B60S 1/66; B60S 3/04; B60B 2900/572; B60B 2900/541

(57) ABSTRACT

A rim protector. The rim protector includes a planar cover having a first side, a second side, and a circular perimeter edge. A handle is disposed on the first side of the cover. A lip is disposed along the perimeter edge on the second side of the cover and extends outwardly therefrom. The lip is configured to rest on the edge of a wheel rim such that the cover shrouds the outward facing side of the wheel rim. The rim protector prevents cleaning solution or other chemicals from contacting the wheel rim when a tire is being cleaned, and further prevents dust accumulation on the wheel rim when a vehicle is in storage for extended periods.

### CROSS REFERENCE TO RELATED APPLICATIONS

This application claims the benefit of U.S. Provisional Application No. 62/212,049 filed on Aug. 31, 2015. The above identified patent application is herein incorporated by reference in its entirety to provide continuity of disclosure.

### FIELD OF THE INVENTION

The present invention relates to vehicle wheel rim covers. More specifically, the present invention provides a rim protector for covering a rim of a vehicle while an individual sprays tire shine or tire cleaner onto the tire.

### BACKGROUND OF THE INVENTION

Individuals with vehicles often clean the vehicle as part of regular maintenance. Some portions of the vehicle accumulate greater amounts of dirt and grime than other portions. For example, vehicle tires collect large amounts of dirt, dust, tar, road debris, and other contaminants. Tires can be difficult to clean without using very strong chemicals. These strong chemicals can damage the rim of the vehicle if the rim is not protected. It is therefore desirable to provide a protective cover for a rim that prevents chemicals from contacting the rim while the tire is being cleaned.

Devices have been disclosed in the known art that relate to covers for vehicle rims. These include devices that have been patented and published in patent application publications. These devices generally relate to rim covers, such as U.S. Pat. No. 7,374,248, U.S. Published Patent Application Number 2013/0033093, U.S. Pat. No. 6,692,085, U.S. Pat. No. 6,598,942, U.S. Published Patent Application Number 2003/0201666, and U.S. Pat. No. 6,227,623.

These devices have several known drawbacks. The devices known in the art fail to provide a rim protector having a perimeter lip that supports the rim protector on the edge of the rim during use. These devices further fail to provide a rim protector having a perimeter lip and a handle for easy attachment and removal of the device.

In light of the devices disclosed in the prior art, it is submitted that the present invention substantially diverges in design elements from the prior art and consequently it is clear that there is a need in the art for an improvement to existing rim protecting devices. In this regard the instant invention substantially fulfills these needs.

### SUMMARY OF THE INVENTION

In view of the foregoing disadvantages inherent in the known types of rim protectors now present in the known art, the present invention provides a rim protector wherein the same can be utilized for providing convenience for the user when protectively covering a wheel rim while cleaning a tire attached thereto.

The rim protector includes a planar cover having a first side, a second side, and a circular perimeter edge. A handle is disposed on the first side of the cover. A lip is disposed along the perimeter edge on the second side of the cover and extends outwardly therefrom. The lip is configured to rest on the edge of a wheel rim such that the cover shrouds the outward facing side of the wheel rim.

An object of the present invention is to provide a rim protector having all of the advantages of prior art rim covering devices and none of the disadvantages.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of a rim protector according to the present invention.

FIG. 2 shows a rear perspective view of a rim protector according to the present invention.

FIG. 3 shows a perspective view of a rim protector according to the present invention in use to protect a rim.

### DETAILED DESCRIPTION OF THE INVENTION

Reference is made herein to the attached drawings. Like reference numerals are used throughout the drawings to depict like or similar elements of the rim protector. For the purposes of presenting a brief and clear description of the present invention, the preferred embodiment will be discussed as used for protecting a rim during cleaning of the tire. The figures are intended for representative purposes only and should not be considered to be limiting in any respect.

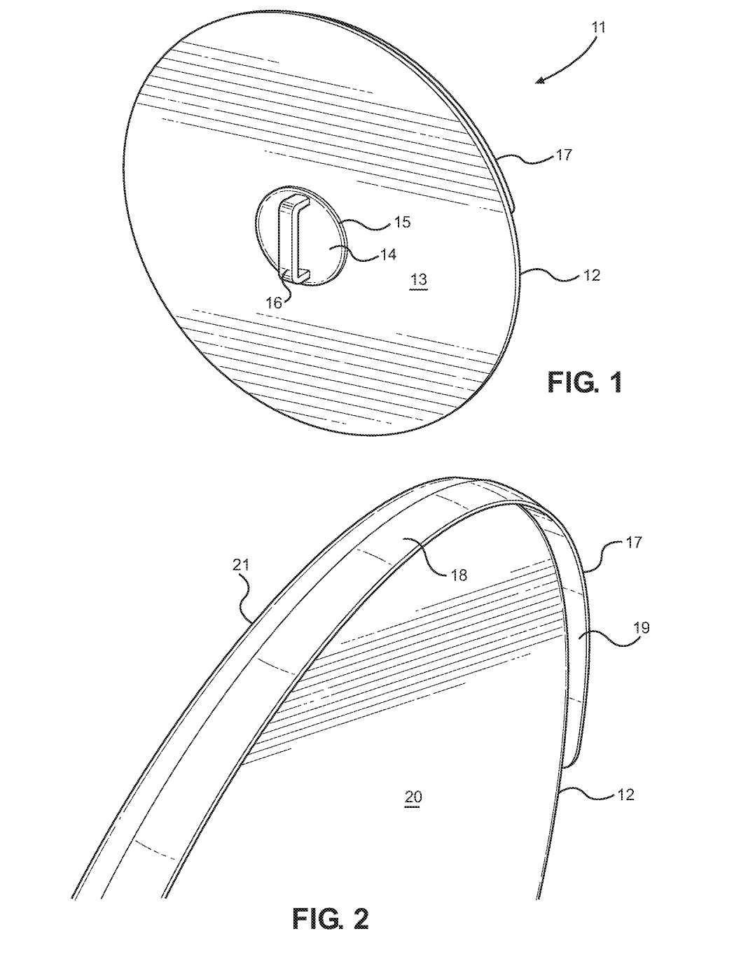

Referring now to FIG. 1, there is shown a front perspective view of a rim protector according to the present invention. The rim protector 11 generally comprises a planar cover having a perimeter edge 12. The perimeter edge 12 is circular in order to maintain the same shape as a wheel rim. A lip 17 is disposed on an upper portion of the perimeter edge 12 and is configured to support the rim protector 11 on the edge of a wheel rim.

The cover further comprises first side 13 having a handle 16 disposed thereon. The handle 16 extends outwardly from the first side 13 of the cover and allows a user to grasp the rim protector 11 when hanging it on a wheel rim or removing it therefrom. In the illustrated embodiment, the handle 16 is disposed on a handle base 14 which is disposed on the first side 13 of the cover #. The handle base 14 is preferably positioned in the center of the cover # in order to evenly distribute the weight of the rim protector 11 when it is lifted via the handle 16. The handle base 14 is raised with respect of the first side 13 of the cover # and further comprises a circular perimeter 15, similar to the perimeter edge 12 of the cover #, each of which further ensure even weight distribution.

Referring now to FIG. 2, there is shown a rear perspective view of a rim protector according to the present invention. The cover # further comprises a second side 20 that contacts the outer surface of a wheel rim when the rim protector is secured thereto. The lip 17 extends from the second side 20 of the cover such that it is perpendicular thereto. The lip 17 further comprises an arcuate perimeter 21 that aligns with the perimeter edge 12 of the cover. When secured to a wheel rim, an outer side 18 of the lip 17 contacts the tire while an inner side 19 of the lip 17 contacts the edge of the wheel rim and supports the rim protector thereon. In the illustrated embodiment, the length of the lip 17 is less than half the circumference of the perimeter edge 12 of the cover. This allows the rim protector to easily hang from the edge of a wheel rim without additional frictional engagement therewith. In one use, the cover is positioned adjacent to the exterior side of a wheel. The lip is inserted at the highest point between/over the wheel rim such that the lip supports the cover over a substantial portion of the rim. The cover is preferably made from a corrosion resistant material that does not deteriorate with constant exposure to cleaning chemicals.

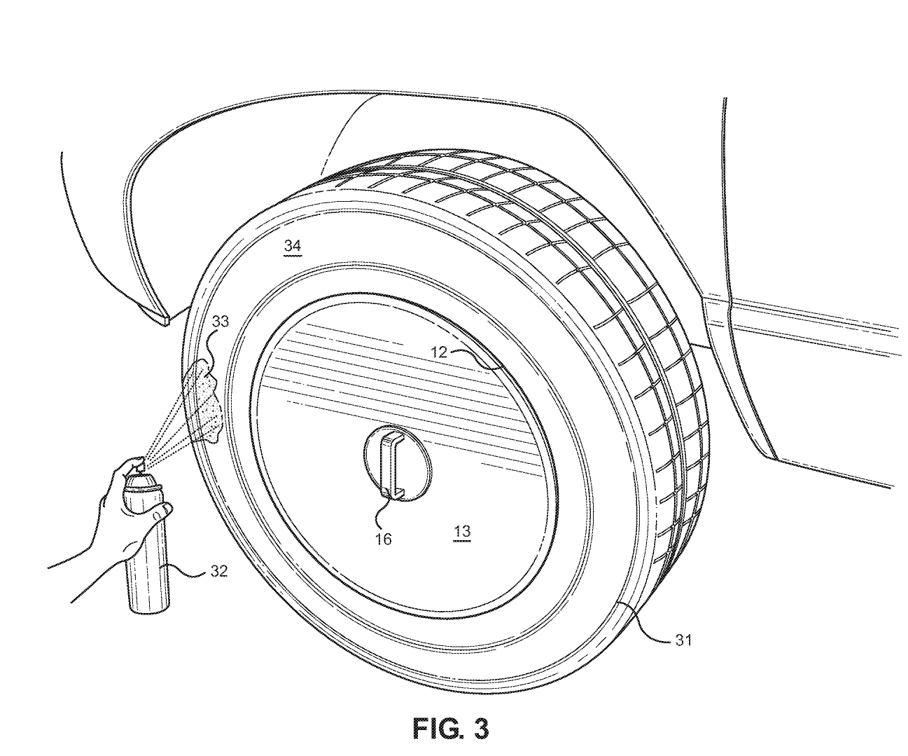

Referring now to FIG. 3, there is shown a perspective view of a rim protector according to the present invention in use. The rim protector is secured to a vehicle wheel such that the sidewall 34 of the tire 31 is exposed. The exact size of the rim protector may vary such that the perimeter edge 12 is equal to the perimeter of the particular wheel rim covered by the rim protector. This allows cleaning solution 33 disposed from a cleaning can 32 to effectively clean the tire 31 without contacting the wheel rim to which the tire is secured. Any overspray of the cleaning solution 33 contacts the first side 13 of the cover rather than an outer surface of the wheel rim. The rim protector may additionally be utilized to prevent dust from accumulating on the wheel rim when the vehicle is in storage for extended periods. When the vehicle is ready to be used again, the rim protector may be easily removed from the wheel rim via the handle 16.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A rim protector comprising:
a planar cover comprising a first side, a second side, and a circular perimeter edge;
a handle disposed on the first side of the planar cover;
a lip disposed on the circular perimeter edge on the second side and extending outwardly therefrom; and
wherein the lip is configured to rest on an edge of a wheel rim such that the planar cover shrouds an outward facing side of the wheel rim.

2) The rim protector of claim 1, wherein the lip is perpendicular to the second side of the planar cover.

3) The rim protector of claim 1, wherein the lip comprises an arcuate shape.

4) The rim protector of claim 1, wherein the lip comprises a length less than half of a circumference of the circular perimeter edge.

5) The rim protector of claim 1, further comprising a handle base disposed on the first side, wherein the handle is connected to the handle base and extends outward therefrom.

6) The rim protector of claim 5, wherein the surface of the handle base is raised with respect to the first side of the cover.

7) The rim protector of claim 5, wherein the handle base comprises a circular perimeter.

8) The rim protector of claim 1, wherein the planar cover comprises a corrosion resistant material.
